(19) United States
(12) Patent Application Publication
(10) Pub. No.: US 2026/0258564 A1
(43) Pub. Date: Sep. 3, 2026

(54) ALL-METAL KNITTED SPACER MESH FOR ELECTROCHEMICAL CELLS

(71) Applicant: ACS Industries, Inc., Lincoln, RI (US)

(72) Inventors: Timothy Davenport, Cumberland, RI (US); George Greenwood, Tiverton, RI (US)

(73) Assignee: ACS Industries, Inc., Lincoln, RI (US)

(21) Appl. No.: 19/163,027

(22) PCT Filed: Mar. 11, 2024
(86) PCT No.: PCT/US2024/019426

§ 371 Date: Sep. 8, 2025

Related U.S. Application Data
(60) Provisional application No. 63/489,772, filed on Mar. 12, 2023.

(51) Int. Cl. C25B 13/05; C25B 1/04; C25B 9/73; C25B 11/03; C25B 11/046

(52) U.S. Cl. CPC C25B 13/05; C25B 9/73; C25B 11/03; C25B 11/046; C25B 1/04

(57) ABSTRACT

An all-wire knitted spacer mesh is utilized as an electrode/flow field/collector plate within an alkaline electrolyzer cell. A double-layer or multilayer all-wire knitted spacer mesh may be used as a combination electrode/bipolar plate/electrode to bridge an electrode flow field gap and gas seal between two adjacent transport separators.

### BACKGROUND OF THE DISCLOSURE

### (1) Field of the Invention

The present disclosure relates generally to the construction of electrochemical cells and knitted spacer mesh fabrics (warp knit or weft knit), and more particularly to an all-metal wire knitted spacer mesh (warp knit or weft knit) for use as an elastic element and/or flow field and/or electrode in an electrochemical cell.

### (2) Description of Related Art

The construction and operation of electrochemical cells is generally well known in the art. In recent years, an increasing interest in hydrogen gas production has opened the doors for development of novel and improved hydrogen electrolyzer configurations and new materials to drive down the cost of manufacturing and operation.

### SUMMARY OF THE DISCLOSURE

The present disclosure will generally refer to an alkaline hydrogen electrolyzer as an exemplary embodiment. However, it should be understood that the knit spacer materials described herein may be useful in any number of different electrochemical cell types and/or configurations.

An alkaline hydrogen electrolyzer typically comprises a cell containing an alkaline electrolyte solution, and metal electrodes (anode and cathode) suspended in the alkaline solution and separated by a porous separator which allow the transport of OH⁻ ions for the reaction to take place.

A classic electrolyzer design may have solid electrodes and a gap between the electrodes and the separator whereas a newer zero-gap design may have porous or perforated electrodes which are in direct contact with the separator, eliminating the gaps. In a zero-gap electrolyzer, the metal electrodes may be a perforated material fabricated from pure nickel (anode side) or a metal coated with a nickel-based compound (cathode side—nickel plate coated with nickel sulfide—NiS) which serves as a catalyst. Applying a current across the electrodes releases hydrogen at the cathode side and oxygen at the anode side.

A commercial scale electrolyzer is a stack of individual cells with water inputs and gas outputs. Because of the conduction of electricity through the stack, it is critical that the various layered structures have good conductivity throughout.

In exemplary embodiments of the invention, an all-wire knitted spacer mesh may be utilized as an electrode within the cell, and a double layer or multilayer all-wire knitted spacer mesh may be used as a combination electrode/bipolar plate.

A conventional knitted (warp knit or weft knit) spacer mesh is comprised of two outer knitted layers (upper and lower flat or planar textile layers) interconnected via a plurality of spacer yarns forming a spacer layer therebetween. The spacer yarns can be interconnected with the outer layers by stitching during fabrication. In the case of the present disclosure, all of the yarns or filaments (wires) used in the knitting and stitching processes comprise metal wires. In the exemplary embodiment, both the upper and lower textile layers and the spacer mesh layer are knitted from metal yarns which may include, metal wires, metal alloy filaments, or other conducting materials, conductive metal-coated filaments or wires or metal alloys suitable for the respective structure intended within the electrochemical cell.

The spacer layer is thicker dimensionally than the outer knitted layers but is characterized by a loose air permeable structure and provides an elasticity in the direction of the thickness of the mesh structure. The upper and lower textile knit layers are denser in structure forming the outer surfaces while the loosely knitted inner spacer layer creates a more open structure. The spacer layer may act as an elastic element due to an energy absorbing zone or a flow field for an electrochemical cell. Since all of the wires are metal, the entire structure is conductive and one or both of the outer layers may act as an electrode layer within an electrochemical cell, a bipolar plate, or a flow field layer.

In some embodiments, during or after the knitting, one of the outer layers may be covered with brazing powder and flux and then brazed in an oven to form a gas seal on one side. In this regard, the single layer spacer mesh may then serve as a solid collector plate on one side and a porous electrode on the opposing side with an electrolyte flow field therebetween.

In other exemplary embodiments, an all-wire, double-layer or multilayer knitted spacer mesh for an electrochemical cell may include multiple textile and spacer layers and function as an electrode/bipolar plate/electrode pack within a multi-cell electrolyzer.

In one double-layer embodiment, a double-layer all-wire knitted spacer mesh may be knit in a single operation and is comprised of a first outer all-metal knitted textile layer interconnected to a middle all-metal textile knit layer with a first spacer layer and an opposed second outer all metal knitted textile layer connected to the middle all-metal knitted layer with a second spacer layer, creating a sandwich structure. During knitting, the middle layer is covered with brazing powder and flux and then brazed in an oven to form a gas seal between the outer layers. In this regard, the inner textile layer of the double-layer spacer mesh may then serve as a bipolar plate within the cell.

In another embodiment, two separate all-wire knitted spacer meshes may be independently knitted and a coating of brazing power and flux applied to one surface of each. The coated surfaces may then be overlaid and brazed together to form a solid inner layer gas seal in the double-layer spacer mesh.

In all embodiments, the single or multiple-layer spacer meshes may simultaneously act as elastic elements (with elastic properties that can be independently varied), collector plates, bipolar plates, electrodes, transport layers and/or flow fields within an electrochemical cell. Because the structure is all-metal, the entire single-layer or multi-layer spacer mesh is conductive throughout its entire thickness and across its length and width.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWING FIGURES

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a perspective view of an exemplary prior art zero-gap single-cell alkaline electrolyzer;

FIG. 2 is a perspective view of a single layer all-metal knitted spacer mesh in accordance with the teachings of the present invention;

FIG. 3 is an enlarged cross-sectional view thereof;

FIG. 4 is a cross-sectional view of another exemplary single-layer spacer mesh with one outer textile knit surface layer thereof coated and brazed to form a bipolar plate/gas seal on one side thereof;

FIG. 5 is a cross-sectional view of an exemplary double-layer spacer mesh with the inner textile knit layer coated and brazed to form a bipolar plate/gas seal in between the two outer layers;

FIG. 6 is a cross-sectional view of another exemplary double-layer spacer mesh formed by layering two individual single-layer spacer meshes and brazing them together to form a bipolar plate/gas seal in between the two outer layers;

FIG. 7 is a cross-sectional view of an exemplary single cell alkaline electrolyte electrochemical cell utilizing two single-layer spacer meshes (outer layer brazed) as electrode/flow field/collector plate sections placed on opposing sides of the separator and captured within upper and lower end plates or housing elements;

FIG. 8 is a cross-sectional view of another single cell exemplary alkaline electrolyte electrochemical cell utilizing two single-layer spacer meshes as electrode/flow field/contact layer sections placed on opposing sides of the separator and captured within upper and lower collector plates and end plates or housing elements; and

FIG. 9 is a cross-sectional view of an exemplary double-cell alkaline electrolyte electrochemical cell utilizing two single-layer spacer meshes (outer layer brazed) as electrode/flow field/collector sections placed on the outer sides of a multi-layer (middle bipolar plate) spacer mesh and separators and captured within upper and lower end plates or housing elements.

### DETAILED DESCRIPTION OF EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art, will recognize that these terms are merely relative to the system and device being discussed and are not universal.

The present disclosure will generally refer to an alkaline hydrogen electrolyzer as an exemplary embodiment. However, it should be understood that the knitted spacer materials described herein may be useful in any number of different electrochemical cell types and/or configurations.

Referring to FIG. 1, an alkaline hydrogen electrolyzer 10 typically comprises a cell housing 12 containing an alkaline electrolyte solution 14 (such as H₂O+KOH or H₂O+NaOH) (10-50% concentration), and metal electrodes (anode 16 and cathode 18) (typically nickel or nickel alloys) suspended in the alkaline solution 14 and separated by a porous separator 20 which allows the transport of OH⁻ ions for the reaction to take place. The separator 20 separates the opposed reaction zones, is impermeable to gases but must be selectively permeable to OH⁻ ions. An exemplary material for the separator is a porous material sold under the trademarked name of Zirfon Perl™ produced by Agfa. It is composed of an open mesh polyphenylene sulfide fabric, which is symmetrically coated with a mixture of about 15% polysulfone and about 85% of zirconium oxide (ZrO). It may have a thickness of 0.5 mm, a porosity of 55%, the same density as water and a maximum operating temperature of 110° C.

While a classic pre-1960's electrolyzer design may have solid electrodes and a gap between the electrodes and the separator, newer zero-gap designs (as illustrated in FIG. 1) will have porous or perforated electrodes 16, 18 which are in direct contact with the separator 20, eliminating the gaps. In a zero-gap electrolyzer 10, the metal electrodes 16, 18 may be a perforated material fabricated from pure nickel (anode side) or a metal coated with a nickel-based compound (cathode side—nickel plate coated with nickel sulfide—NiS) which serves as a catalyst. Applying a current across the electrodes 16, 18 releases hydrogen at the cathode side and oxygen at the anode side.

As will be discussed hereinbelow, a larger scale electrolyzer is simply a stack of repeating, electrically connected individual cells with water inputs and gas outputs. Because of the conduction of electricity through the stack, it is critical that the various layered structures have good conductivity throughout.

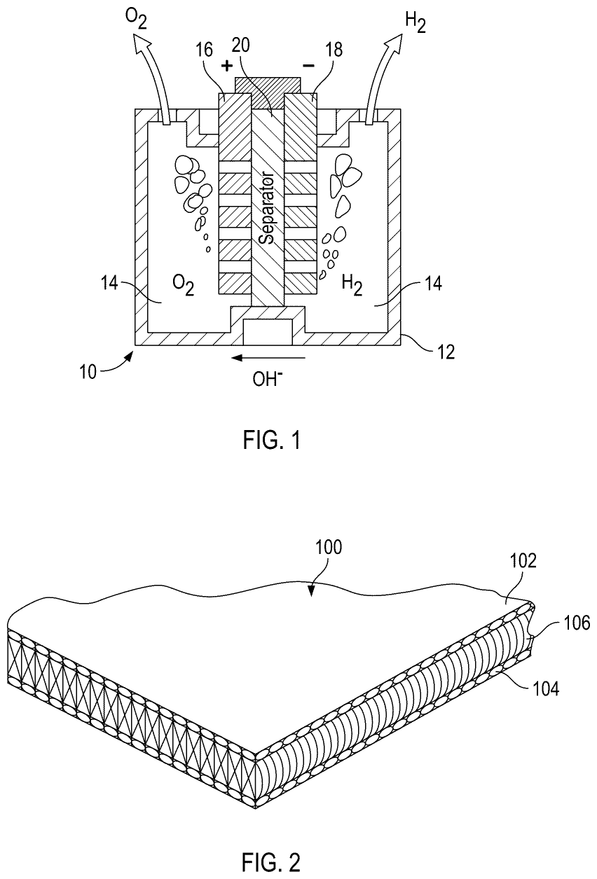

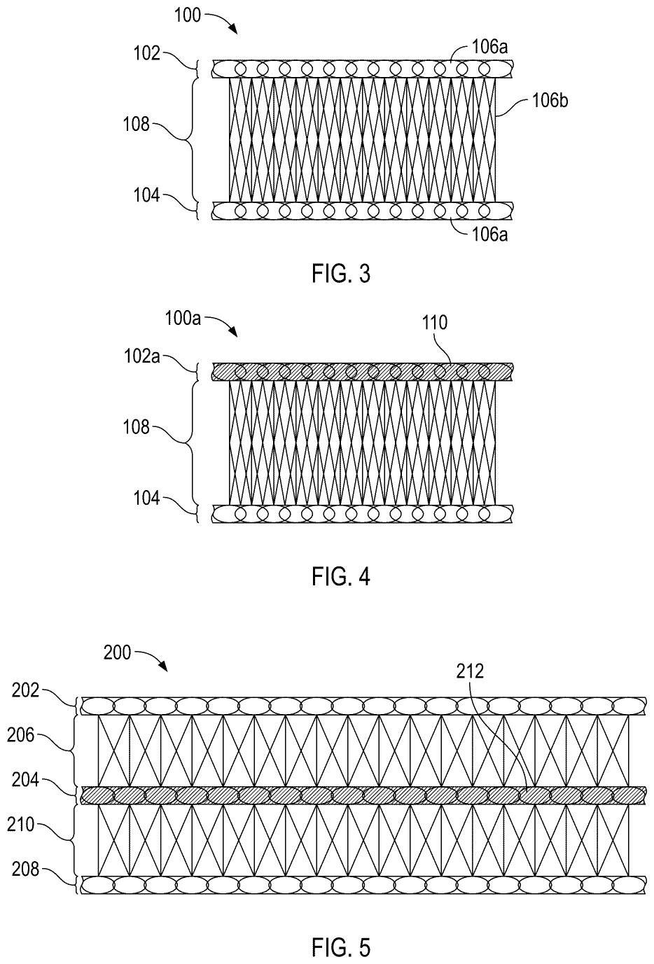

Referring to FIGS. 2 and 3, a knitted spacer mesh construction 100 is illustrated. In exemplary embodiments of the invention, an all-wire knitted spacer mesh 100 may be utilized as an electrode/flow field/bipolar plate within an electrochemical cell structure.

A knitted (warp knit or weft knit) spacer mesh 100 is comprised of two outer knitted layers 102, 104 (upper and lower flat or planar “textile” layers) primarily knitted from mesh yarns 106a and are interconnected via a plurality of spacer yarns 106b forming a spacer layer 108 therebetween. Warp and weft knitting generally uses a plurality of mesh and spacer yarns 106a, 106b which are knitted both within the layers 102, 104 and travel between the layers and are intermixed.

The term “textile” as used herein refers to the knitted structure of the layer rather than the materials used. The spacer yarns 106b are interconnected with the outer layers 102, 104 by stitching during the knitting process.

In the case of the present disclosure, all of the yarns (mesh 106a and spacer 106b) used in the knitting and stitching processes comprise metal yarns or metal wires or metal filaments. In the exemplary embodiment, both the upper and lower textile layers 102, 104 and the spacer mesh layer 108 are knitted from metal “yarns” which may include, metal wires, metal alloy wires, metal filaments, metal alloy filaments, conductive metal or metal alloy coated filaments or other suitable metal coated elements for the respective structure intended within the electrochemical cell. The term “yarn” 106 as used in this disclosure is also considered to include multi-strand configurations with braided wires or twisted yarns, each of which is composed of a multitude of individual metal wires.

In some contexts, the term “wire” may be used in place of yarn and may be understood as a strand that is not composed of individual sub-elements and therefore has a single, limited cross section. For ease of knitting with existing knitting machines, a wire may have, for example, a round cross-sectional profile.

The metal yarns 106 may have a diameter of between 0.03 and 0.3 mm, and particularly between 0.05 and 0.15 mm. Such a diameter range ensures, on the one hand, that sufficient thermal and/or electrical conduction can take place within the framework of conventional materials and that, on the other hand, the bends in the metallic yarn that occur during stitch formation in a warp-knitted spacer fabric do not result in breakage of the material. As noted above, nickel, nickel-plated, and nickel alloy metals are preferred for alkaline electrolyzers.

The spacer layer 108 is thicker dimensionally than the outer knitted layers 102, 104 and is characterized by a loose air permeable structure that also provides an elasticity in the direction of the thickness of the mesh structure. The upper and lower textile knit layers 102, 104 are denser in structure forming the outer surfaces while the loosely knitted inner spacer layer 108 creates a more open structure. The spacer layer 108 may act as an elastic compression element or “mattress” as termed in the electrochemical cell art, due to an energy absorbing zone and may also simultaneously function as a flow field for the electrolyte solution 14 within the electrochemical cell. Since all of the wires 106 are metal, the entire structure is conductive and one or both of the outer layers 102, 104 may act as an electrode layer within the electrochemical cell, or a bi-polar plate, while the spacer layer 108 may function as an interior flow field layer while electrically connecting the outer layers 102, 104.

Referring to FIG. 4, in another embodiment 100a, either during or after the knitting, one of the outer layers (using 102 as an example) may be covered with brazing powder 110 and flux and then brazed in an oven to form a solid layer gas seal 102a on one side. The brazing powder 110 melts and fills the gaps in the textile knitted structure of the outer layer 102 creating a solid surface 102a. In this regard, the single layer spacer mesh 100a may then serve as a solid bipolar plate on one side 102a, and a porous electrode on the opposing side 104 with an electrolyte flow field (spacer layer) 108 therebetween.

Referring now to FIG. 5, in another exemplary embodiment, an all-wire, double-layer or multilayer knitted spacer mesh 200 for an electrochemical cell may include multiple textile and spacer layers and function as an electrode/bipolar plate/electrode pack within a multi-cell electrolyzer.

The double-layer all-wire knitted spacer mesh 200 as illustrated in FIG. 5, may be knit in a single operation and is comprised of a first outer all-metal knitted textile layer 202 interconnected to a middle all-metal textile knit layer 204 with a first spacer layer 206 and an opposed second outer all-metal knitted textile layer 208 connected to the middle all-metal knitted layer 204 with a second spacer layer 210, creating a sandwich structure. During knitting, the middle layer is covered with brazing powder 212 and flux and then brazed in an oven to create a solid layer between the outer layers 202, 208. In this regard, the middle textile layer 204 of the double-layer spacer mesh 200 may then serve as a solid impermeable gas seal and bipolar plate between two adjacent cells in a multi-cell electrolyzer construction.

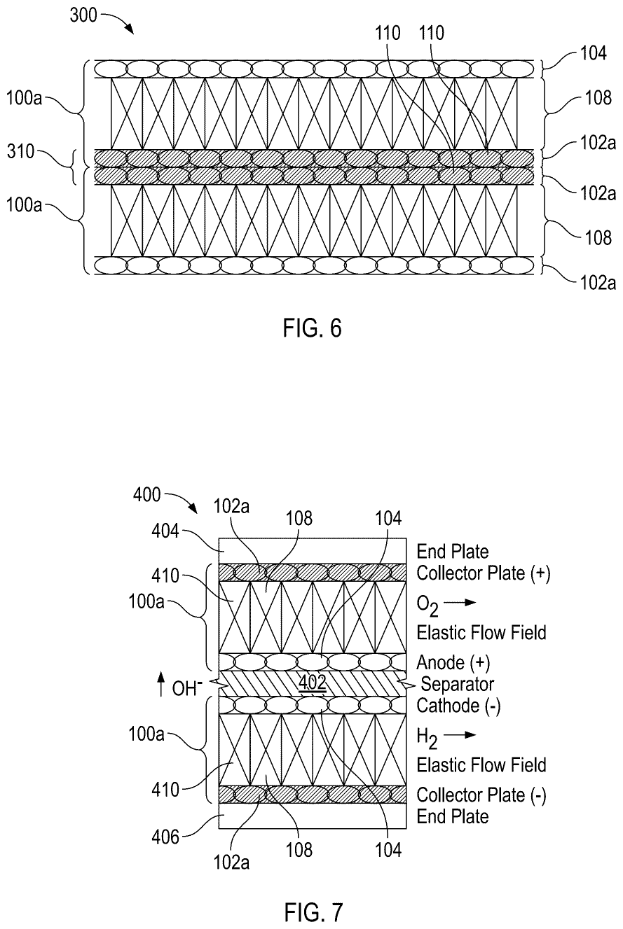

Referring to FIG. 6, in another double-layer spacer mesh embodiment 300, two separate single layer, all-wire knitted spacer meshes 100a may be independently knitted and a coating of brazing power 110 and flux applied to one surface of each. The coated surfaces may then be overlaid and brazed together to form a solid inner layer gas seal 310 in the double-layer spacer mesh 300.

In all embodiments, the single or multiple-layer spacer meshes may simultaneous act as elastic elements (with elastic properties that can be independently varied based on both wire variables and knitting variables), bipolar plates, electrodes, transport layers and/or flow fields within an electrochemical cell. Because the structure is all-metal, the entire single-layer or multi-layer spacer mesh is conductive throughout its entire thickness and across its length and width.

Referring now to FIG. 7, there is illustrated a cross-sectional view of an exemplary single cell alkaline electrolyte electrochemical cell 400 utilizing two single-layer spacer meshes 100a (outer layer brazed) as electrode/flow field/collector plate sections placed on opposing sides of an OH⁻ transport separator 402 and captured within upper and lower end plates or housing elements 404, 406. An alkaline electrolyte 410 (such as H₂O+KOH or H₂O+NaOH) is contained within the cell on both sides of the separator 402. O₂ and H₂ outlet ports (not shown) are formed within the housing structure or end plates to release generated gases per the cell reaction pathways. Power is supplied across the electrodes directly or through the collector plates.

The anode side spacer mesh 100a is brazed on the outer side 102a to form a collector plate/gas seal, while the inner layer 104 functions as a porous (zero-gap) electrode in direct contact with the separator 402 (Zirfon). The inner layer 104 may be knit from NiMo alloy yarns to act as an oxygen catalyst. The cathode side spacer mesh 100a is also brazed on the outer (lower) side 102a to form a collector plate/gas seal, while the inner layer 104 functions as a porous (zero-gap) electrode in direct contact with the separator 402. The cathode side inner layer 104 may be knit from NiFe alloy yarns to act as a hydrogen catalyst. Because of the elastic nature of the spacer layers 108 in both spacer meshes 100a, the cell 400 can be compressed within the end plate structure 404, 406 to squeeze the layered structure into intimate contact and improve conductivity throughout.

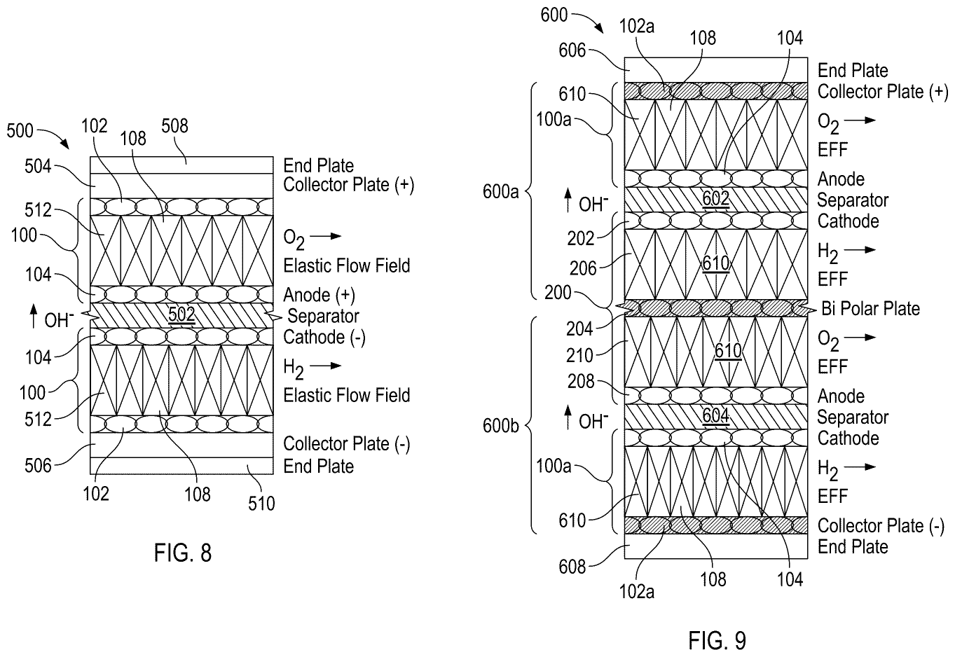

FIG. 8 is a cross-sectional view of an alternative single cell alkaline electrolyte electrochemical cell 500 also utilizing two single-layer spacer meshes 100 FIG. 3) as electrode/flow field/contact layer sections placed on opposing sides of the separator 502 and captured within upper and lower collector plates 504, 506 and end plates 508, 510 or housing elements. In this case, the outer layers 102 are not brazed and are porous as knit. The cell adds separate anode side and cathode side collector plates 504, 506 to form the gas seal on the outer sides of the cell configuration, but is otherwise similar in structure and composition as described above.

Turning now to FIG. 9, there is illustrated a cross-sectional view of an exemplary double-cell alkaline electrolyte electrochemical cell 600 utilizing two single-layer spacer meshes 100 (outer layers brazed) as electrode/flow field/collector plate sections placed on the outer sides of two spaced separators 602, 604 and a double-layer spacer mesh 200, and captured within upper and lower end plates 606, 608 or housing elements.

Similar to the above-described configuration in FIG. 7, the two single-layer spacer meshes 100 are layered on the outsides of first and second spaced separators 602, 604. The outermost layers of the spacer meshes are brazed to form gas seal/collector plates 102a. The respective inner layers 104 facing the separators form the respective anode and cathode. Between the first and second separators 602, 604 there is provided a double-layer all-wire knitted spacer mesh 200. As described in connection with FIG. 5, the double-layer all-wire knitted spacer mesh 200 comprises, a first knitted outer layer 202, a second knitted outer layer 208, a knitted middle layer 204 between the first and second knitted outer layers 202, a first knitted spacer layer 206 between the first knitted outer layer 202 and the knitted middle layer 204, the first knitted spacer layer interconnecting the first knitted outer layer 202 with the knitted middle layer 204, a second knitted spacer layer 210 between the second knitted outer layer 208 and the knitted middle layer 204, the second knitted spacer layer 210 interconnecting the second knitted outer layer 208 with the knitted middle layer 204. The first knitted outer layer 202 is disposed adjacent the first separator 602 and functions as the cathode side of the first cell 600a. The second knitted outer layer 208 is disposed adjacent the second separator 604 and functions as the anode side of the second cell 600b.

The knitted middle layer 204 may be coated with a metal power and a flux and brazed to form a gas impermeable seal/bipolar plate layer between the adjacent cells 600a, 600b.

An alkaline electrolyte (such as H₂O+KOH or H₂O+NaOH) 610 is contained within the elastic flow field (EFF) spacers 108, 206, 210, 108 on both sides of the separators 602, 604.

O₂ and H₂ outlet ports (not shown) are formed within the housing or within the end plate structures 606, 608 to release generated gases per the cell reaction pathways. Power is supplied across the respective electrodes directly or through the collector plates.

Similarly, because of the elastic nature of the spacer layers 108, 206, 210, 108 in all three spacer meshes 100a, 200, the cell 600 can be compressed within the end plates to squeeze the layer structure into intimate contact and improve conductivity throughout.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described.

What is claimed is:

1. A knitted spacer mesh comprising:
a first knitted outer layer;
a second knitted outer layer; and
a knitted spacer layer between the first and second knitted outer layers, the knitted spacer layer interconnecting the first and second knitted outer layers,
wherein the first and second knitted outer layers and the knitted spacer layer comprise a plurality of knitted yarns, and
wherein the plurality of knitted yarns consist exclusively of metal material.

2. The knitted spacer mesh of claim 1, wherein the plurality of knitted yarns consist of metal wire.

3. The knitted spacer mesh of claim 2, wherein the plurality of knitted yarns consist of nickel metal wire.

4. The knitted spacer mesh of claim 1, wherein one of the first and second outer layers is coated with a metal power and a flux and brazed to form a gas impermeable seal layer.

5. The knitted spacer mesh of claim 2, wherein one of the first and second outer layers is coated with a metal power and a flux and brazed to form a gas impermeable seal layer.

6. The knitted spacer mesh of claim 3, wherein one of the first and second outer layers is coated with a metal power and a flux and brazed to form a gas impermeable seal layer.

7. A double-layer knitted spacer mesh comprising;
a first knitted outer layer;
a second knitted outer layer;
a knitted middle layer between the first and second knitted outer layers;
a first knitted spacer layer between the first knitted outer layer and the knitted middle layer, the first knitted spacer layer interconnecting the first knitted outer layer with the knitted middle layer,
a second knitted spacer layer between the second knitted outer layer and the knitted middle layer, the second knitted spacer layer interconnecting the second knitted outer layer with the knitted middle layer,
wherein the first and second knitted outer layers, the knitted middle layer and the first and second knitted spacer layers comprise a plurality of knitted yarns, and
wherein the plurality of knitted yarns consist exclusively of metal material.

8. The knitted spacer mesh of claim 7, wherein the plurality of knitted yarns consist of metal wire.

9. The knitted spacer mesh of claim 8, wherein the plurality of knitted yarns consist of nickel metal wire.

10. The knitted spacer mesh of claim 7, wherein knitted middle layer is coated with a metal power and a flux and brazed to form a gas impermeable seal layer.

11. The knitted spacer mesh of claim 7, wherein knitted middle layer is coated with a metal power and a flux and brazed to form a gas impermeable seal layer.

12. The knitted spacer mesh of claim 7, wherein knitted middle layer is coated with a metal power and a flux and brazed to form a gas impermeable seal layer.

13. An electrochemical cell comprising:
an electrolyte solution;
first and second metal electrodes suspended in the electrolyte solution; and
a separator disposed within the electrolyte solution between the first and second electrodes,
wherein at least one of the first and second electrodes comprises an all-metal wire knitted spacer mesh.

14. The electrochemical cell of claim 3,
wherein, the electrolyte solution is an alkaline electrolyte solution,
wherein the separator is an OH⁻ transport separator,
wherein the all-metal wire knitted spacer mesh comprises a knitted inner layer, a knitted outer layer; and a knitted spacer layer between the knitted inner and outer layers, the knitted spacer layer interconnecting the knitted inner and outer layers,
wherein the knitted inner layer is in direct contact with the separator and functions as the electrode, the electrolyte solution freely flows within the knitted spacer layer and the outer layer functions as a bipolar plate.

15. The electrochemical cell of claim 14,
wherein the outer layer is coated with a metal power and flux and brazed to form a gas impermeable bipolar plate and seal layer.

16. A multi-cell electrochemical cell comprising:
an electrolyte solution;
first and second metal electrodes suspended in the electrolyte solution; and
a first separator disposed within the electrolyte solution adjacent the first electrode,
a second separator disposed within the electrolyte solution adjacent the second electrode,
a double-layer all-wire knitted spacer mesh disposed between the first and second separators, wherein the double-layer all-wire knitted spacer mesh comprises, a first knitted outer layer, a second knitted outer layer, a knitted middle layer between the first and second knitted outer layers, a first knitted spacer layer between the first knitted outer layer and the knitted middle layer, the first knitted spacer layer interconnecting the first knitted outer layer with the knitted middle layer, a second knitted spacer layer between the second knitted outer layer and the knitted middle layer, the second knitted spacer layer interconnecting the second knitted outer layer with the knitted middle layer,
wherein the first knitted outer layer is disposed adjacent the first separator and functions as an electrode,
wherein the second knitted outer layer is disposed adjacent the second separator and functions as an electrode,
wherein knitted middle layer is coated with a metal power and a flux and brazed to form a gas impermeable seal and bipolar layer.

17. The multi-cell electrochemical cell of claim 16,
wherein, the electrolyte solution is an alkaline electrolyte solution,
wherein the separators comprise OH⁻ transport separators,
wherein the first and second knitted outer layers are in direct contact with the first and second separators, and wherein the electrolyte solution freely flows within the knitted spacer layers.
